(19) United States
(12) Patent Application Publication
(10) Pub. No.: US 2025/0271459 A1
(43) Pub. Date: Aug. 28, 2025

(54) Velocity Detecting System Using Known Light Path

(71) Applicant: Jonathan Stanley, Knoxville, TN (US)

(72) Inventor: Jonathan Stanley, Knoxville, TN (US)

(21) Appl. No.: 18/585,410

(22) Filed: Feb. 23, 2024

(51) Int. Cl. G01P 3/36

(52) U.S. Cl. CPC G01P 3/36

(57) ABSTRACT

The velocity detecting system includes an emitter, a receiver, a light path, a measuring system, and a deducer to calculate the velocity of a body without relying on an external body with independent motion or an earlier known body velocity. The emitter radiates light photons which follow a known light path until the photons reach the receiver. The light is measured by a measuring system. Using the measurements, the light path, and the constant speed of light (c), the deducer calculates the velocity of the body in the direction of the light path.

### BACKGROUND

### Field of the Invention

This invention relates to velocity detection systems; more particularly, to a velocity detection system that measures and determines the velocity of the body it is installed on without relying on an external inertial frame of reference or an earlier known body velocity.

### Description of the Related Art

Light is increasingly used as a tool for precise measurement. On May 20, 2019, the distance of a meter was redefined as the length of the path traveled by light in a vacuum over a set period of time. Light refers to electromagnetic radiation of any wavelength, and is not limited to the visible spectrum. The principle that the speed of light is constant has widespread applications, including to velocity detection systems.

For example, Light Detection And Ranging (LIDAR) measures the time for reflected light to return to a receiver. LIDAR can be used to determine the distance between surfaces, and it may be used in a variety of applications. In one application, LIDAR may be used to generate high-resolution 3-D representations of an environment. This 3-D representation is essentially a digitized map of an area of Earth's surface, and the map can be used to help navigate and control autonomous vehicles.

Similarly, Radio Detection and Ranging (radar) also measures the time for reflected radio waves, a form of light, to return to the receiver. The light waves used for radar have a longer effective detection range, as opposed to visible light waves. Radar can be used to detect and track a variety of objects, including but not limited to: aircraft, ships, spacecraft, guided missiles, motor vehicles, cloud formations, and terrain. However, both LIDAR and radar depend on light being reflected off an external object with independent motion. This means that LIDAR and radar systems, as currently configured, suffer from dependency limitations.

The Global Positioning System (GPS) is a network of satellites and receiving devices used to determine the location of object(s) with respect to the Earth. GPS operates by timing the light wave transmissions between satellites orbiting the Earth. A series of consecutive locational GPS measurements can be used to determine an object's velocity on earth's surface. GPS was originally developed for US military purposes, but is now used in a variety of non-military applications. For example, GPS is used in clock synchronization, fleet tracking, navigation, sports, surveying, tectonics, geofencing, astronomy, and more. However, GPS depends on a clear line of sight to the orbiting satellites. These cost billions of dollars to launch and operate and GPS is unable to function underground or without the satellites.

A method to independently detect an object's velocity from a device which itself is fixed to the object would be of considerable value.

There are a family of devices, such as accelerometers and gyroscopes, that may be used in an inertial navigation system to determine the position or velocity of an object using in. If the position and vector of an object are measured or known at a starting time, T-zero, and the angular accelerations and directional accelerations felt by that object are tracked to a second time, T-time, the detected accelerations may be used to calculate the position and vector of the object at T-time. Inertial navigation systems are used in aircraft such that a pilot can navigate through weather systems and clouds where the aircraft is visually and/or communicatively isolated from external references. However, inertial navigation systems which are fixed to a moving object still require that the object's position and vector be known at an earlier time if the object's position and vector at a later time are to be determined.

The prior art lacks a system which may be joined to an object and detect the velocity of the object without interacting with systems in external reference frames or involving previously known object velocities. When discussing the present invention, the object whose velocity is being calculated is referred to as a “body.”

### SUMMARY

The disclosure concerns a system which, when joined to a body, can measure the velocity of the body without relying on an external inertial frame of reference or an earlier known body velocity.

The system comprising an emitter, a receiver, a light path, a measuring system, and a deducer may calculate the velocity of a body. The emitter radiates light photons which travel a known path until the photons reach the receiver. The light traveling between the emitter and the receiver is measured using a measuring system. Using the measurements, such as the length and other properties of the light path and the constant speed of light (c) the deducer calculates the velocity of the body. The emitter and receiver may be two devices or a single device capable of both functions.

### BRIEF DESCRIPTION OF THE DRAWINGS

Other features, combinations, and embodiments will be appreciated by one having the ordinary level of skill in the art of velocity detection systems and accessories upon a thorough review of the following details and descriptions, particularly when reviewed in conjunction with the drawings, wherein:

FIG. 1 shows a side view of a velocity detecting system in accordance with a first illustrated embodiment;

FIG. 2 shows a side view of a multi-axis velocity detecting system in accordance with a second illustrated embodiment;

FIG. 3 shows a side view of a multi-axis velocity detecting system in accordance with a third illustrated embodiment;

FIG. 4 shows a side view of a multi-axis velocity detecting system in accordance with a fourth illustrated embodiment;

FIG. 5 shows a side view of a velocity detecting system in accordance with a fifth illustrated embodiment;

FIG. 6 shows a side view of a velocity detecting system in accordance with a sixth illustrated embodiment; and

FIG. 7 shows a method of detecting velocity.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the terms “LIGHT” and “LIGHT PHOTON” means electromagnetic radiation of any wavelength, not limited to the visible spectrum.

The term “ATTACHED” means permanently joined.

The term “COUPLED” means reversibly joined.

The term “JOINED” means attached or coupled.

Unless explicitly defined herein, terms are to be construed in accordance with the plain and ordinary meaning as would be appreciated by one having skill in the art.

### General Description of Embodiments

A velocity detecting system comprising an emitter, a receiver, a light path, a measuring system, and a deducer is described herein. In some embodiments, a rocket may be traveling through space and requiring independent speed assessment for autonomous navigation. The rocket may serve as the body the velocity detecting device is joined to. In some embodiments, the emitter may be a light emitting diode (LED), and the receiver may be a photodiode receiver. The emitter may be disposed towards the tip of the rocket and a photodiode receiver may be disposed towards the other end of the rocket.

The light path from the emitter to receiver may be set by a straight vacuum tube. The LED can emit light photons which travel along the vacuum tube and are detected by the photodiode. In some embodiments, the length between emitter and receiver may be obtained while at rest and set in the deducer for future calculations. The measuring system is used to measure the elapsed time between when the light photon was emitted by the emitter and received by the receiver. The information from the emitter, receiver, measuring system, or some combination thereof, is communicated to the deducer. The deducer uses the mathematics described below to calculate the velocity of the body in accordance with classical mechanics.

The length of the light path is described as substantially known or substantially measured to an accuracy which allows the deducer to make accurate velocity calculations. Similarly, the measured elapsed time is measured to an accuracy which allows the deducer to make accurate velocity calculations. The precision of the length of the light path or the measured elapsed time necessary for the deducer calculations will be apparent to one skilled in the art.

The velocity calculations performed by the deducer may be based on the following mathematics. The velocity of the rocket (v) may be derived based on light's constant speed (c) and the measured elapsed time (t) it takes for light to travel the length of the light path (l) from emitter to receiver. While the rocket is moving, the elapsed time that it takes a light photon to travel from emitter to receiver is measured by the measuring system. The deducer reports the velocity of the rocket from the data in accordance with classical mechanics. In this embodiment: v=(l/t)−c. The distance light must travel from emitter to receiver is equal to the length of the vacuum tube, when the rocket is stationary. However, since light's speed is independent of the motion of the rocket, the distance light must travel from emitter to receiver diminishes as the rocket moves forward.

As a counterfactual scenario, the light path length between the emitter and the receiver is 10 meters, the constant speed of light is 9 meters per second (m/s), and the rocket is traveling forward at 1 m/s. During the first second, light would travel 9 meters from the emitter at the rocket tip and towards the receiver end. Simultaneously during that second, the receiver moves 1 meter towards the emitter. The light reaches the receiver having traveled 9 meters over a 1 second period. In this counterfactual scenario, the deducer would output velocity as follows: v=(l/t)−c=10 m/1 s−9 m/s=1 m/s.

In some situations, it may be desirable to determine velocity vectors for a number of directional axes, for example and without limitation, when navigating three-dimensional space and error correction. In some embodiments, a rocket may be configured with a velocity detecting system similar to that described in the single-axis embodiment. However, this rocket has three velocity detection systems which have their three light paths oriented along three separate axes, for example, the X-axis, Y-axis, and Z-axis. In some embodiments, the different axes may be orthogonal to each other. In other embodiments, as may be useful for error correction, the different axes may not be orthogonal to each other.

The steps for a single axis of velocity detection may be repeated for multi-axis velocity detection such that there is an emitter-receiver light path aligned for multiple axes. Any number of velocity detection systems may be set up to calculate the velocity in any desired directional axis. In repeating the steps for additional axes, a multi-axis vector may be obtained. The multi-axis vector is the vector sum of the various axis vectors which were deduced. In one embodiment, there are three systems for each axis, nine systems in total, to provide error correction and redundancy. These steps may also be repeated in series over time to obtain a number of multi-axis vectors and facilitate autonomous navigation capabilities.

Given light's rapid speed, it may be difficult or expensive to measure the duration of light's travel with desired precision. In such situations, the light path may be modified to facilitate additional approaches to accurately calculating a velocity. In another embodiment, the path of the light may be reflected such that the light travels repeatedly down a substantially similar path such that the total length of travel is increased. This increased length allows for improved precision in the timing measurements. In another embodiment, a rocket and velocity detecting system is as described in the first embodiment. In this embodiment, the vacuum tube may be replaced by a length of optical fiber which may have a refractive index of 1.444. A refractive index above 1.0 indicates light will propagate along the optical fiber more slowly than a vacuum. Therefore, the elapsed time for light to travel the light path will be longer. Increasing the refractive index of the path may facilitate improved precision of the timing measurements.

The received light may also be measured for blueshift or redshift doppler effects. A shortened wavelength (blueshift) indicates the degree the receiver is moving towards the emitter. An increased wavelength (redshift) indicates the degree the receiver is moving away from the emitter.

The optical fiber may also be wound in a number of loops to extend the distance light must travel. The additional distance increases the time of light's travel and facilitates improved precision of the timing measurements.

Winding the optical fiber also introduces at least two axes of travel during transmission. In some embodiments, the winding is circular to maximize light's travel in each of the two axes. In other embodiments, the winding is made to minimize travel outside a single axis.

The emitter and receiver may be the same device with the wound optical fiber directing back to the source for a feedback loop. The feedback may be used to modulate the pulse, amplitude, or phase of the emitted light to allow the harmonized frequency to be measured and used to deduce the velocity. The feedback may also be used to render a light interference pattern from which velocity may be deduced through interferometry.

A feedback loop which emits a pulse of light upon arrival of the previous emitted light may develop a harmonized frequency which can be measured in hertz. The measured hertz can be used to mathematically derive the velocity. Such a feedback loop may also emit light in a different phase, amplitude, or frequency, as a way to measure timing. The timing, phase, amplitude, and frequency measurements can be used to derive velocity. In such embodiments, the device may be calibrated under a number of precisely known velocities and the results set in the deducer. This allows the deducer to calculate velocity independently without knowing the length of the travel path. A system of beamsplitters may be used to create interference patterns, as known through interferometry. The scale of the measured interference patterns can be used to derive the velocity.

Beamsplitters may be used to split the portions of the light towards a number of receivers. Conversely, light from a number of emitters may be reflected to arrive at a single receiver.

In some situations, the ability to locate a body throughout the earth and without dependence on external devices may provide additional benefit. In another embodiment, a vehicle may be traveling underground and near the Earth's surface. A velocity detecting system is joined to the vehicle for each of the axes: X-axis, Y-axis, and Z-axis. The three-dimensional vector velocity of the vehicle may be deduced at regular intervals and each interval is timestamped. The timestamp provides important context for the body. The time of day indicates if earth's rotation is aligned with orbital movement, or opposing. As the earth rotates around the axis of its poles, this effect on velocity is most significant at the equator and away from earth's center. The effect is least significant towards the poles or towards earth's center.

Additionally, the day of the year indicates earth's position in its oblong orbital path. The vector of earth's velocity of orbit is opposing during opposing. Incidentally, the 365 days of the year roughly correspond to 1 degree of change each day to complete a 360-degree cycle. The entirety of the solar system may also be in movement. Deriving the velocity of the vehicle at regular intervals over time may be used to determine the degree of change of the velocity and compare it to the expected change of velocity from Earth's rotation and orbit. This comparison can be used to indicate the vehicle's position within the earth and plotted over time. The plot of the vehicle's location over time may also be used to derive its current velocity or track its velocity history.

### Manufacturing

Each of the components of the velocity detecting system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### First Illustrated Embodiment

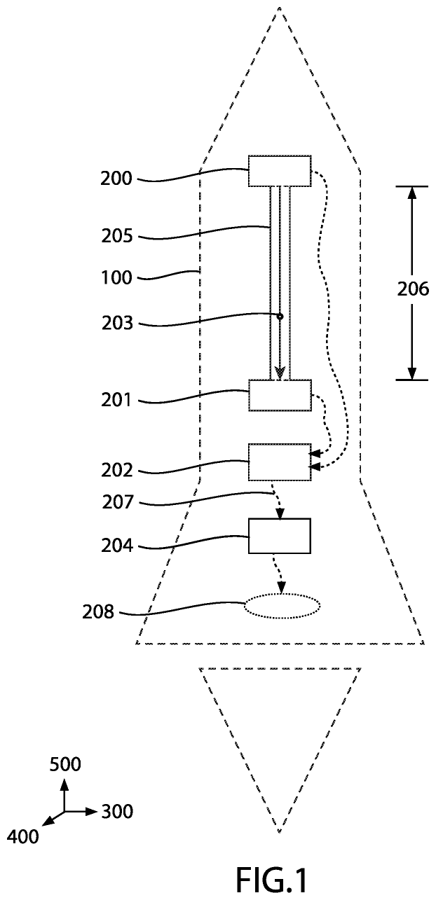

In a first illustrated embodiment as depicted in FIG. 1, we have a rocket body (100) traveling through space and requiring independent speed assessment for autonomous navigation. A light emitting diode (LED) emitter (200) is joined towards the front of the rocket and a photodiode receiver (201) is joined towards the other end of the rocket. A light path (205) for the light from the emitter to the receiver is created by a straight vacuum tube. The straight vacuum tube serves as the light path length (206) in this embodiment. The light path length is oriented along the Z-Axis (500), and has a substantially known light path length. The measuring system (202) will measure elapsed time (207) for a light photon (203) to travel from the emitter to the receiver. The measured elapsed time and light path length are to be used by the deducer (204) to calculate the velocity (208) in the Z-Axis.

### Second Illustrated Embodiment

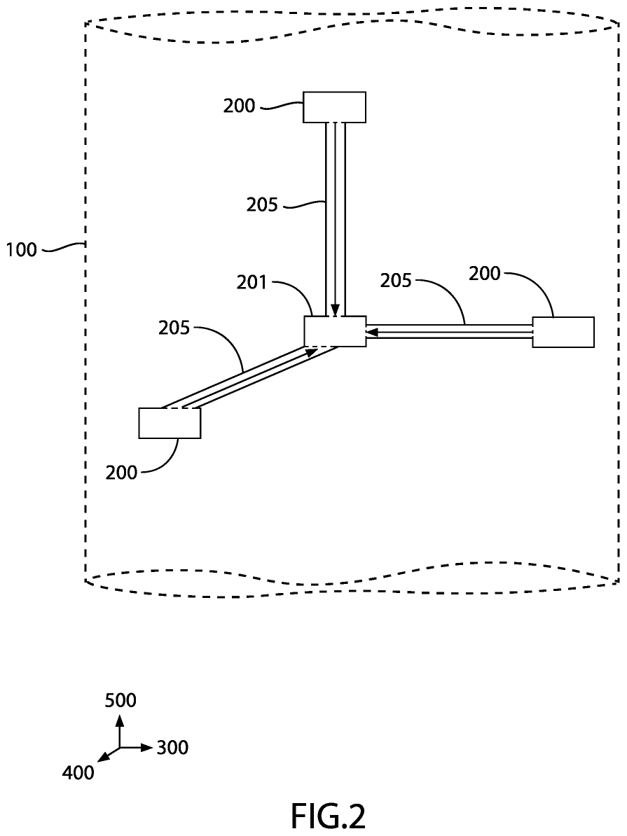

In a second illustrated embodiment as depicted in FIG. 2, three velocity detecting systems are joined to a rocket body (100). One velocity detecting system has an emitter (200), a receiver (201), and a light path (205) along the Z-Axis (500). The other two velocity detecting systems utilize the same receiver, but separate emitters resulting in light paths along the lateral X-Axis (300) and Y-Axis (400).

### Third Illustrated Embodiment

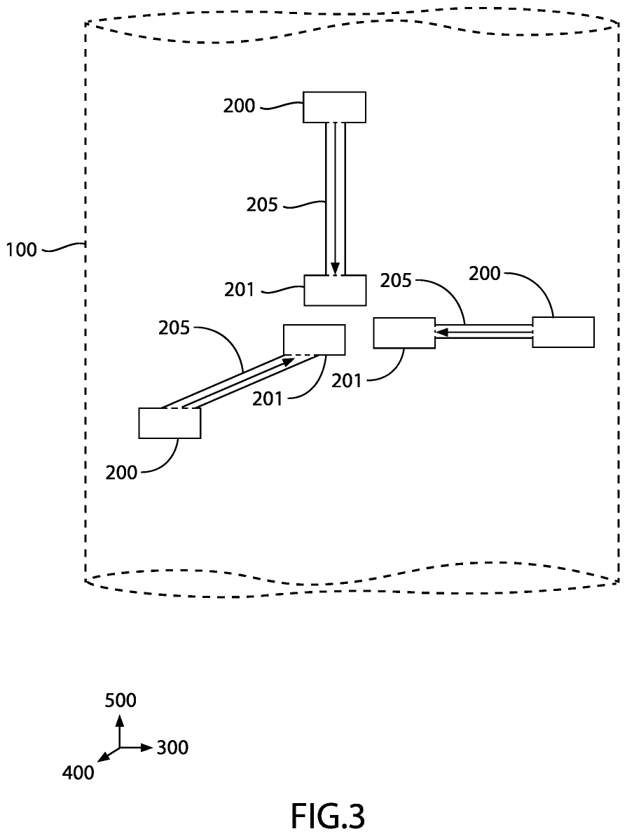

In a third illustrated embodiment as depicted in FIG. 3, three velocity detecting systems are joined to a rocket body (100). One velocity detecting system has an emitter (200), a receiver (201), and a light path (205) along the Z-Axis (500). Two velocity detecting systems have emitters, receivers, and light paths along the lateral X-Axis (300) and Y-Axis (400).

### Fourth Illustrated Embodiment

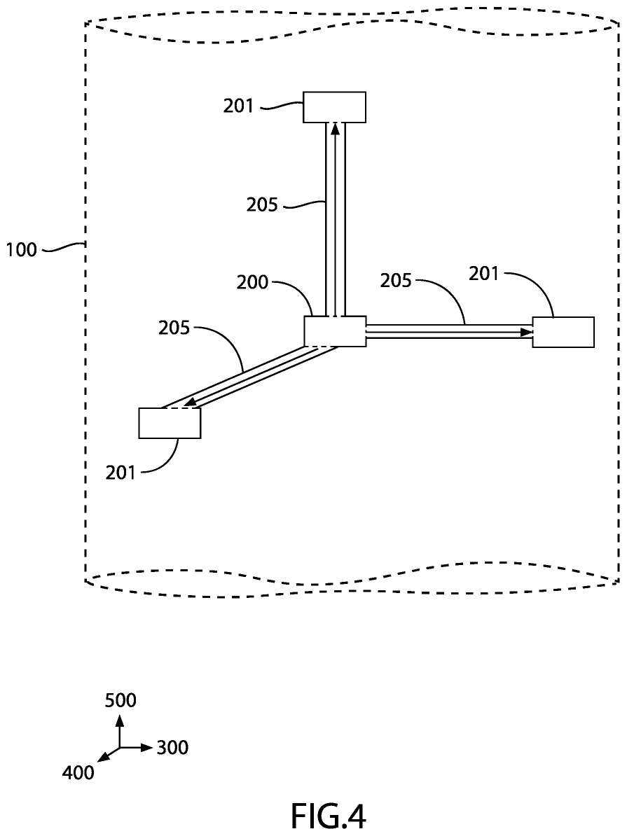

In a fourth illustrated embodiment as depicted in FIG. 4, three velocity detecting systems are joined to a rocket body (100). One velocity detecting system has an emitter (200), a receiver (201), and a light path (205) along the Z-Axis (500). The other two velocity detecting systems utilize the same emitter, but separate receivers resulting in light paths along the lateral X-Axis (300) and Y-Axis (400).

### Fifth Illustrated Embodiment

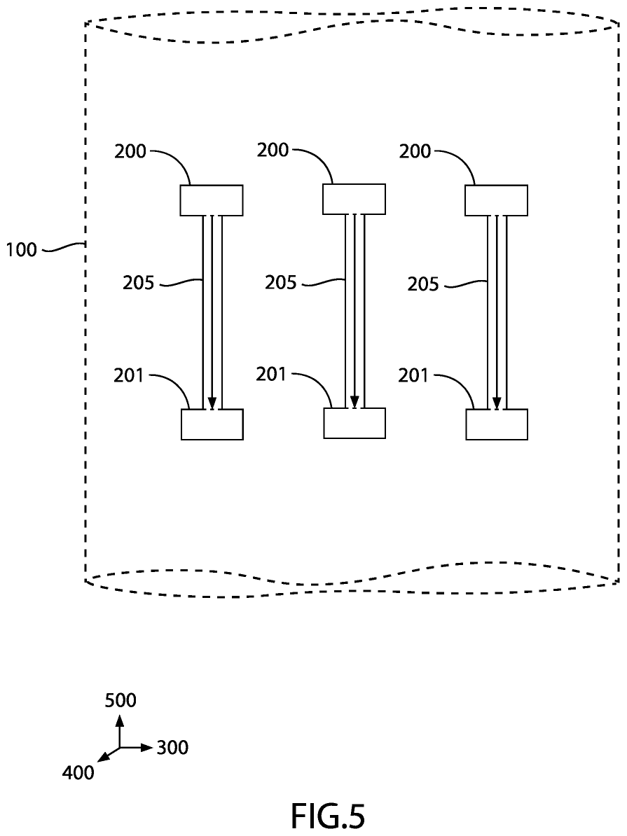

In a fifth illustrated embodiment as depicted in FIG. 5, multiple velocity detecting systems are joined to a rocket body. This embodiment has three velocity detecting systems in a similar orientation along the Z-Axis (500). Each of the three velocity detecting systems have an emitter (200), a receiver (201), and a light path (205). Having redundant velocity detecting systems may improve the velocity deduction accuracy and reliability.

### Sixth Illustrated Embodiment

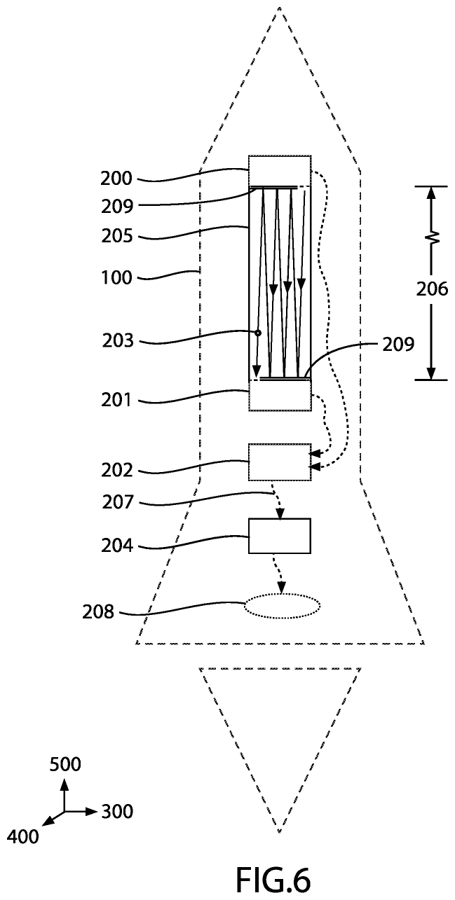

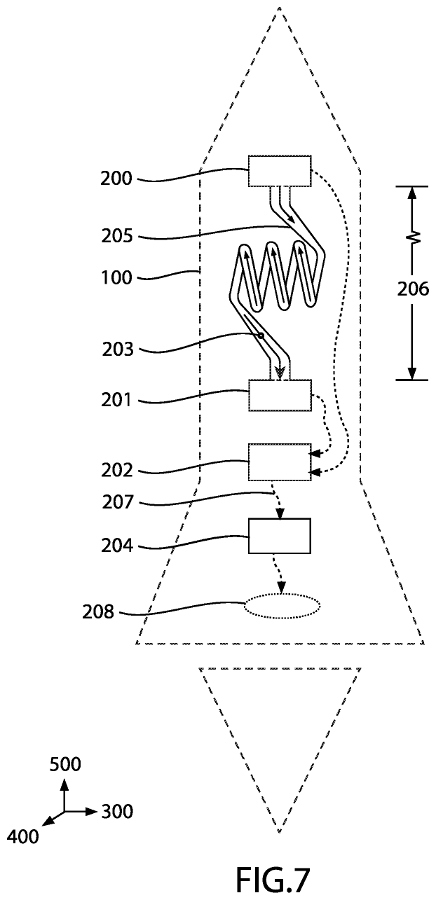

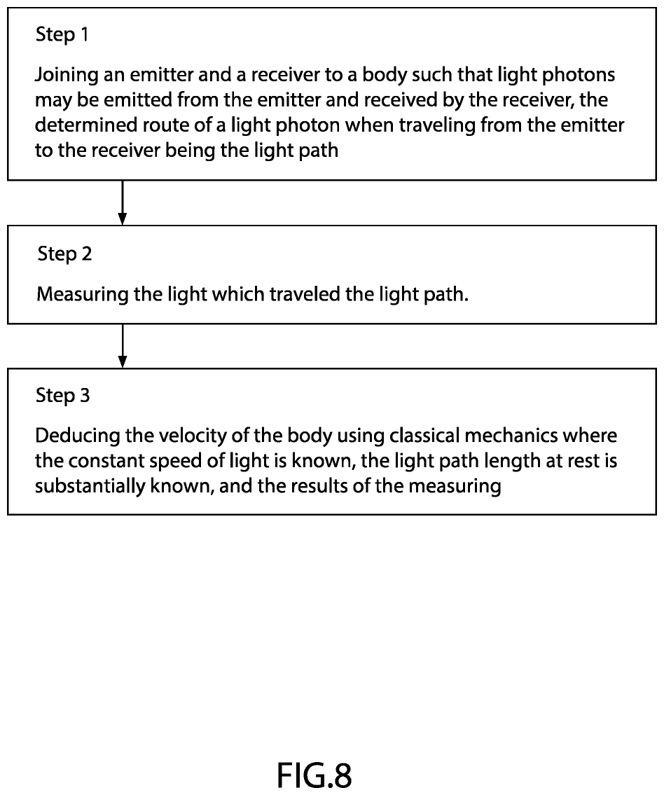

In a sixth illustrated embodiment as depicted in FIG. 6, the light path (205) of a velocity detecting system is reflected between two reflectors (209) to increase the light path length (206). The reflected light path shown in FIG. 7 is not to scale. The reflected light path is shown with two reflectors, but reflected light paths with more or fewer reflectors are within the scope of this disclosure. The reflected light path is shown with six reflections, but reflected light paths with more or fewer reflections are within the scope of this disclosure.

### Seventh Illustrated Embodiment

In a seventh illustrated embodiment as depicted in FIG. 7, the light path (205) of a velocity detecting system is wrapped in a generally helical shape to increase the light path length (206). The helical light path shown in FIG. 6 is not to scale. The helical light path is shown with three loops, but helical light paths with more or fewer loops are within the scope of this disclosure.

Feature List

| | | |
|---|---|---|
| [50] | Body | (100) |
| [51] | Emitter | (200) |
| [52] | Receiver | (201) |
| [53] | Measuring System | (202) |
| [54] | Light Photon | (203) |
| [55] | Deducer | (204) |
| [56] | Light Path | (205) |
| [57] | Light Path Length | (206) |
| [58] | Measured Elapsed Time | (207) |
| [59] | Velocity | (208) |
| [60] | Reflector | (209) |
| [61] | X-Axis | (300) |
| [62] | Y-Axis | (400) |
| [63] | Z-Axis | (500) |
| t path. | | |

What is claimed is:

1. A velocity detecting system, comprising:
a. An emitter which can emit light photons,
b. A receiver which can detect the light photons from the emitter,
c. A Z light path; the Z light path being the determined route of the light photon when traveling from the emitter to the receiver,
d. A measuring system; the measuring system being capable of measuring the emitted light,
e. A deducer; the deducer communicates with the measuring system, the deducer being capable of calculating the Z velocity in accordance with classical mechanics and the known constant velocity of light.

2. The system of claim 1, wherein:
a. A combination of system components are replicated for a number of axes, such that a multi-axis vector is obtained.

3. A velocity detecting system, comprising:
a. A number of emitters which can emit light photons;
b. A number of receivers which can detect when the light photons reach the number of receivers;
c. A number of light paths;
d. A number of measuring systems; the measuring systems being capable of measuring the emitted light;
e. A number of deducers; the deducers being capable of communicating with the number of measuring systems, the deducer being capable of calculating the velocity of the object along the number of axes in accordance with classical mechanics and the known constant velocity of light

4. The velocity detecting system as in claim 3, wherein:
a. The light path is controlled using reflection, beamsplitters, refractive material, or some combination thereof.

5. The velocity detecting system as in claim 1, wherein:
a. The deducer calculates Z velocity multiple times over a sequential period of time.

6. The velocity detecting system as in claim 5, wherein:
a. The deducer is further capable of deriving a coordinate position of the body using the deduced velocity.

7. The velocity detecting system as in claim 6, wherein:
a. The deducer is further capable of mapping the position of the body in relation to its environment, wherein the environment is stationary, moving, orbiting, rotating, or some combination thereof.

8. A method for determining the velocity of a body, comprising:
a. Joining an emitter and a receiver to a body such that light photons may be emitted from the emitter and received by the receiver, the determined route of a light photon when traveling from the emitter to the receiver being the light path,
b. Measuring the emitted light.
c. Deducing the velocity of the body using classical mechanics where the constant speed of light is known, the light path at rest is substantially known, and the results of the measuring.

9. The method of claim 8, further comprising:
a. Deducing the velocity using the following measurements: refractive index of the path, timing for pulses of light, Doppler Effect of the light waves, amplitude of the light waves, frequency of the light waves, phase of the light waves, interferometry, or some combination thereof.

10. The method of claim 8, further comprising:
a. Repeating the steps 8a.-8c. for a velocity detecting system for a number of axes.

11. The method of claim 8, further comprising:
a. Repeating the step 8c. multiple times over a sequential period of time.

12. The method of claim 11, further comprising:
a. Deriving a coordinate position of the body using the deduced velocity.

13. The method of claim 12, further comprising:
a. Mapping the position of the body in relation to its environment, wherein the environment is stationary, moving, orbiting, rotating, or some combination thereof.
